(19) United States
(12) Patent Application Publication
(10) Pub. No.: US 2003/0115382 A1
(43) Pub. Date: Jun. 19, 2003

(54) Peripheral device testing system and a peripheral device testing method which can generally test whether or not a peripheral device is normally operated

(75) Inventor: Shigeru Kimoto, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, Tokyo (JP)

(21) Appl. No.: 10/320,409

(22) Filed: Dec. 17, 2002

(30) Foreign Application Priority Data
Dec. 19, 2001 (JP) 2001-386156

(51) Int. Cl. G06F 3/00

(52) U.S. Cl. 710/1

(57) ABSTRACT

A peripheral device testing apparatus, includes an executing unit and a reporting unit. The executing unit is included in a firmware installed on an information processing apparatus. The executing unit executes a test program for testing a peripheral device connected to the information processing apparatus to generate a testing result. The reporting unit is included in the firmware. The reporting unit outputs an installation request indicating of requesting to install the peripheral device on the information processing apparatus to an operating system installed on the information processing apparatus when an operation of the peripheral device is normal as a result of the testing result.

### BACKGROUND OF THE INVENTION

1. Field of the Invention

The present invention relates to a peripheral device testing system and a peripheral device testing method. More particularly, the present invention relates to a peripheral device testing system and a peripheral device testing method, which test whether or not a peripheral device connected during a drive of an operating system (hereafter, referred to as [OS]) is normally operated.

2. Description of the Related Art

Conventionally, when a peripheral device is connected to a bus, such as PCI (Peripheral Component Interconnect) and the like, installed or incorporated in a personal computer (hereafter, referred to as [PC] and the like, whether or not the peripheral device is normally operated is tested before it is installed into the OS.

In particular, if there is a trouble in the peripheral device connected during an activation of the OS, there may be a case that an operation of the OS can not be continued. Thus, a test of the peripheral device is important.

Here, Japanese Laid Open Patent Application (JP-A, 2000-267950) discloses a device test diagnosing system that can test a peripheral device without any influence on an operation of a system.

This device testing diagnosing system, if a device is installed, sends a message indicating that a new device is installed from the device to an input output controller, and a device driver receiving the message activates a test executing unit.

The test executing unit loads a test program from a device, which is a test target apparatus, to a memory, and executes a test in accordance with the test program.

An input output process to a device, which is requested at a time of a test execution, is executed through the device driver.

An end message of the input output process from the device is received by the device driver and passed to the test executing unit. A result of the test is passed through a message sending receiving unit to a kernel of the OS.

Also, Japanese Laid Open Patent Application (JP-A 2000-305678) discloses a method of mounting a rear path that can be electrically separated as a hardware and then carrying out a test by using a card, which is hot-plugged, as the rear path. [0009-1]

Japanese Laid Open Patent Application (JP-A-Heisei, 5-165669) discloses the following information processor. This information processor is the information processor, which is composed of a plurality of active line insertion removal packages that can be inserted or removed even if an electric power is at an on-state, for continuing an operation by switching an active line insertion removal package having a trouble to an active line insertion removal package in a spare system, including: a memory for storing a test program to carry out an operational check of the active line insertion removal package; a detector for detecting an insertion of the active line insertion removal package; and a unit for reading out the test program from the memory if the detector detects the insertion of the active line insertion removal package, and then carrying out the operational check of the active line insertion removal package.

Japanese Laid Open Patent Application (JP-A 2000-10904) discloses the following communication apparatus. This communication apparatus is the communication apparatus having a plurality of slots into which a package is inserted, wherein a communication path is established when a configuration data is set for the package inserted into the slots. This is characterized in that any package can be inserted into the slots and that a data processor for setting a configuration data for the inserted package is provided.

Japanese Laid Open Patent Application (JP-A 2001-92646) discloses the following device driver switching system. This device driver switching system is the device driver switching system, which is provided with computer peripheral devices and a computer for determining only one device driver corresponding to a connected peripheral device on the basis of a plug and play method, wherein the computer has a usually operational device driver to be used when the peripheral devices are usually used and a testing device driver to be used when the peripheral devices are tested and a function of selecting any one of the usually operational device driver and the testing device driver in accordance with an attribute information data written to an attribute memory of the connected peripheral device, and wherein the peripheral device has a switch to select and set any one of the usual operation and the test and a function of writing any one of the attribute information data for the usual operation and the test to the attribute memory.

Japanese Laid Open Patent Application (JP-A 2001-222502) discloses the following computer system. This computer system is the plug and play computer system including: (a) a computer having a visual display and at least one external serial passport to connect at least one peripheral device; (b) an operating system, which is resident in the computer and is programmed so as to dynamically set the computer system, and has a first subroutine to generate a first inner message indicating that the operating system detects the change in the number of the devices connected to the computer and a second subroutine to generate a second inner message indicating that the operating system has completed a setting process; and (c) a setting report program, which is resident in the computer, for receiving the first and second messages and generating a visual indication to quickly report to the user the time when an insertion and a removal of a plug and play device into or from the computer is not safe.

However, in the case of Japanese Laid Open Patent Application (JP-A 2000-267950), in order to execute the test program, the input output controller requires a CPU corresponding to a central processor. Also, the input output controller requires a memory to load the test program.

The test program that can be executed in CPU of the input output controller needs to be included in the peripheral device of a test target. Thus, the testable peripheral device is limited. Moreover, the OS is limited to such a type in which the kernel is operated in the CPU on the side of the central processor and the test driver is operated on the side of the input output controller. For this reason, it is necessary to develop the test program for each OS installed in the PC and the like. Since the generalization is poor, its improvement is desired.

Also, in the case of Japanese Laid Open Patent Application (JP-A 2000-305678), it is necessary to include the dedicated hardware. Also, in order to execute the test of the peripheral device, this execution depends on the OS. Thus, similarly to the case when the test program is executed by the OS, the generalization is poor, and its improvement is desired.

Moreover, actually, even if the peripheral device can normally carry out the necessary operation, for example, when the deposition of dust and the like on a connection terminal of the peripheral device disables the connection to the system side to be successfully attained, a trouble may be erroneously judged to be induced in a bus through which the system and the peripheral device are connected. Thus, there may be a case that the misjudged result is sent to the OS during the test of the peripheral device or after the test.

### SUMMARY OF THE INVENTION

The present invention is accomplished in view of the above mentioned problems. Therefore, an object of the present invention is to generally test whether or not a peripheral device is normally operated. Another object of the present invention is to disable a misjudged result to be sent to OS when a peripheral device is inspected.

In order to achieve an aspect of the present invention, a peripheral device testing apparatus, includes: an executing unit included in a firmware installed on an information processing apparatus, wherein the executing unit executes a test program for testing a peripheral device connected to the information processing apparatus to generate a testing result; and a reporting unit included in the firmware, wherein the reporting unit outputs an installation request indicating of requesting to install the peripheral device on the information processing apparatus to an operating system installed on the information processing apparatus when an operation of the peripheral device is normal as a result of the testing result.

In order to achieve another aspect of the present invention, a peripheral device testing apparatus, includes: an executing unit included in a firmware installed on an information processing apparatus, wherein the executing unit executes a test program for testing a peripheral device connected to a connection section of the information processing apparatus to generate a testing result; and a specific reporting unit included in the firmware, and wherein the connection section separates the peripheral device from the information processing apparatus in response to a separating request, and wherein the specific reporting unit outputs the separating request to the connection section when the operation of the peripheral device is abnormal as the result of the testing result.

In this case, the connection section outputs a connection information indicating that the peripheral device is connected to the connection section to the firmware when the peripheral device is connected to the connection section.

Also in this case, a plurality of the peripheral devices are able to be connected to the connection section, and wherein the connection information includes an identifier of one of the plurality of the peripheral devices connected to the connection section, and wherein a plurality of the test programs are corresponding to the plurality of the peripheral devices, respectively, and wherein the executing unit executes the test program corresponding to the peripheral device of the identifier included in the connection information inputted by the firmware.

In this case, the test program is stored into the information processing apparatus.

Also in this case, a part of a memory of the information processing apparatus is set to be a memory area into which the test program is written, and the part is set to be the memory area that the firmware can use but the operating system cannot use.

Further in this case, the firmware makes one of a first request of an operating system installed on the information processing apparatus to be disconnected from the firmware and a second request of the operating system to stop an operation of the operating system when the peripheral device is connected to the connection section.

In this case, the executing unit executes the test program after the operating system is disconnected from the firmware or the operating system stops the operation of the operating system.

Also in this case, the information processing apparatus is any one of a personal computer, a memory, a server, a workstation and a processor.

Further in this case, The peripheral device testing apparatus further includes: a bus which connects the operating system to the peripheral device at a normal state; an interrupting unit which interrupts the bus before the executing unit executes the test program; a returning unit which returns the interrupted bus to the normal state when the operation of the peripheral device is normal as the result of the testing result.

In this case, the peripheral device includes a storage into which an information used by the operating system is stored, and a connecting section which connects the storage to the information processing apparatus.

In order to achieve still another aspect of the present invention, a peripheral device testing apparatus, includes: a first connection section included in an information processing apparatus, wherein a first peripheral device is connected to the first connection section and the first connection section is accessible by an operating system of the information processing apparatus; a second connection section included in the information processing apparatus, wherein a second peripheral device is connected to the second connection section and the second connection section is accessible by the operating system; a disconnect unit which outputs a disconnect request indicating of disconnecting the first connection section from the operating system to the operating system when the first peripheral device is connected to the first connection section, wherein the disconnect unit outputs a first power-ON request indicating of supplying a power supply to a first connecting unit through which the first peripheral device is connected to the first connection section to the first connection section after the operating system disconnects the first connection section from the operating system in response to the disconnect request, and wherein the first connection section turns on a power for the first connecting unit in response to the first power-ON request; an executing unit included in a firmware installed on the information processing apparatus, wherein the executing unit executes a test program for testing the first peripheral device to generate a testing result after the power for the first connecting unit is turned on; and an incorporating section, wherein the incorporating section outputs an incorporating request indicating of requesting to incorporate the first connection section into the information processing apparatus to the operating system when an operation of the first peripheral device is normal as a result of the testing result.

In order to achieve yet still another aspect of the present invention, a peripheral device testing apparatus, includes: a first connection section included in an information processing apparatus, wherein a first peripheral device is connected to the first connection section and the first connection section is accessible by an operating system of the information processing apparatus; a second connection section included in the information processing apparatus, wherein a second peripheral device is connected to the second connection section and the second connection section is accessible by the operating system; a disconnect unit which outputs a disconnect request indicating of disconnecting the first connection section from the operating system to the operating system when the first peripheral device is connected to the first connection section, wherein the disconnect unit outputs a first power-ON request indicating of supplying a power supply to a first connecting unit through which the first peripheral device is connected to the first connection section to the first connection section after the operating system disconnects the first connection section from the operating system in response to the disconnect request, and wherein the first connection section turns on a power for the first connecting unit in response to the first power-ON request; an executing unit included in a firmware installed on the information processing apparatus, wherein the executing unit executes a test program for testing the first peripheral device to generate a testing result after the power for the first connecting unit is turned on; and a specific reporting unit included in the firmware, and wherein the first connection section separates the first peripheral device from the information processing apparatus in response to a separating request, and wherein the specific reporting unit outputs the separating request to the first connection section when the operation of the first peripheral device is abnormal as the result of the testing result.

In this case, the disconnect unit outputs, to the first connection section, an output prohibition request indicating of prohibition of outputting a judgement result that a failure occurs in a bus connected to the first peripheral device to the operating system, and wherein the first connection section does not output the judgement result to the operating system in response to the output prohibition request.

Also in this case, the disconnect unit outputs, to the first connection section, an output prohibition request indicating of prohibition of outputting a judgement result that a failure occurs in a bus connected to the first peripheral device to the operating system, and wherein the first connection section does not output the judgement result to the operating system in response to the output prohibition request.

Further in this case, the disconnect unit outputs a second power-ON request indicating of supplying a power supply to a second connecting unit through which the second peripheral device is connected to the second connection section to the second connection section when the first peripheral device is connected to the first connection section, and wherein the second connection section turns on a power for the second connecting unit in response to the second power-ON request.

In this case, the peripheral device testing apparatus further includes: a storage into which an information used by the operating system is stored and which is accessible by the first and second peripheral devices, and wherein the operating system accesses to the storage with the second peripheral device.

In order to achieve another aspect of the present invention, a peripheral device testing method, includes: (a) executing a test program for testing a peripheral device connected to an information processing apparatus to generate a testing result in response to a command from a firmware of the information processing apparatus; and (b) outputting an installation request indicating of requesting to install the peripheral device on the information processing apparatus to an operating system installed on the information processing apparatus when an operation of the peripheral device is normal as a result of the testing result.

In order to achieve still another aspect of the present invention, a peripheral device testing method, includes: (c) executing a test program for testing a peripheral device connected to a connection section of an information processing apparatus to generate a testing result in response to a command from a firmware of the information processing apparatus; (d) separating the peripheral device from the information processing apparatus in response to a separating request; and (e) outputting the separating request to the connection section when the operation of the peripheral device is abnormal as the result of the testing result.

In order to achieve yet still another aspect of the present invention, a peripheral device testing method, includes: (f) providing a first connection section included in an information processing apparatus, wherein a first peripheral device is connected to the first connection section and the first connection section is accessible by an operating system of the information processing apparatus; (g) providing a second connection section included in the information processing apparatus, wherein a second peripheral device is connected to the second connection section and the second connection section is accessible by the operating system; (h) disconnecting the first connection section from the operating system when the first peripheral device is connected to the first connection section; (i) supplying a power supply to a first connecting unit through which the first peripheral device is connected to the first connection section after the (h); (j) executes a test program for testing the first peripheral device to generate a testing result after the (i); and (k) incorporating the first connection section into the information processing apparatus when an operation of the first peripheral device is normal as a result of the testing result.

The present invention is a peripheral device testing system, which while OS installed in an information processor is driven, tests whether or not a peripheral device connected to the information processor is normally operated, before an installation under a control of the OS, wherein the peripheral device testing system includes: a memory for storing a test program to test an operation of the peripheral device in accordance with a command of a firmware installed in the information processor; an executing unit for executing the test program stored in the memory; and a reporter for reporting an installation request of the peripheral device to the OS if the peripheral device is normally operated as the executed result of the test program by the executing unit.

Also, the present invention is a peripheral device testing method, which while OS installed in an information processor is driven, tests whether or not a peripheral device connected to the information processor is normally operated, before an installation under a control of the OS, wherein the peripheral device testing methods executes a test program in accordance with a command of a firmware installed in the information processor, and tests an operation of the peripheral device, and then reports an installation request of the peripheral device to the OS, if the peripheral device is normally operated.

That is, the present invention is designed such that when the OS receiving a connection request of a hot plug sends an inquiry to the firmware, the firmware performs an interruption on CPU, and the device is tested by the firmware. For this reason, in a case of a single processor, the control of the CPU is not done by the OS. Thus, the operation of the OS is suspended meanwhile.

### BRIEF DESCRIPTION OF THE DRAWINGS

FIG. 1 is a block diagram showing a part of a diagrammatically inner configuration of PC or the like of a first embodiment in the present invention;

FIG. 2 is a flowchart showing an operation of PC or the like of FIG. 1;

FIG. 3 is a block diagram showing a part of a diagrammatically inner configuration of PC or the like of a second embodiment in the present invention; and

FIG. 4 is a flowchart showing an operation of PC or the like of FIG. 3.

### DESCRIPTION OF THE PREFERRED EMBODIMENTS

Embodiments of the present invention will be described below with reference to the attached drawings.

(First Embodiment)

[Explanation of Configuration]

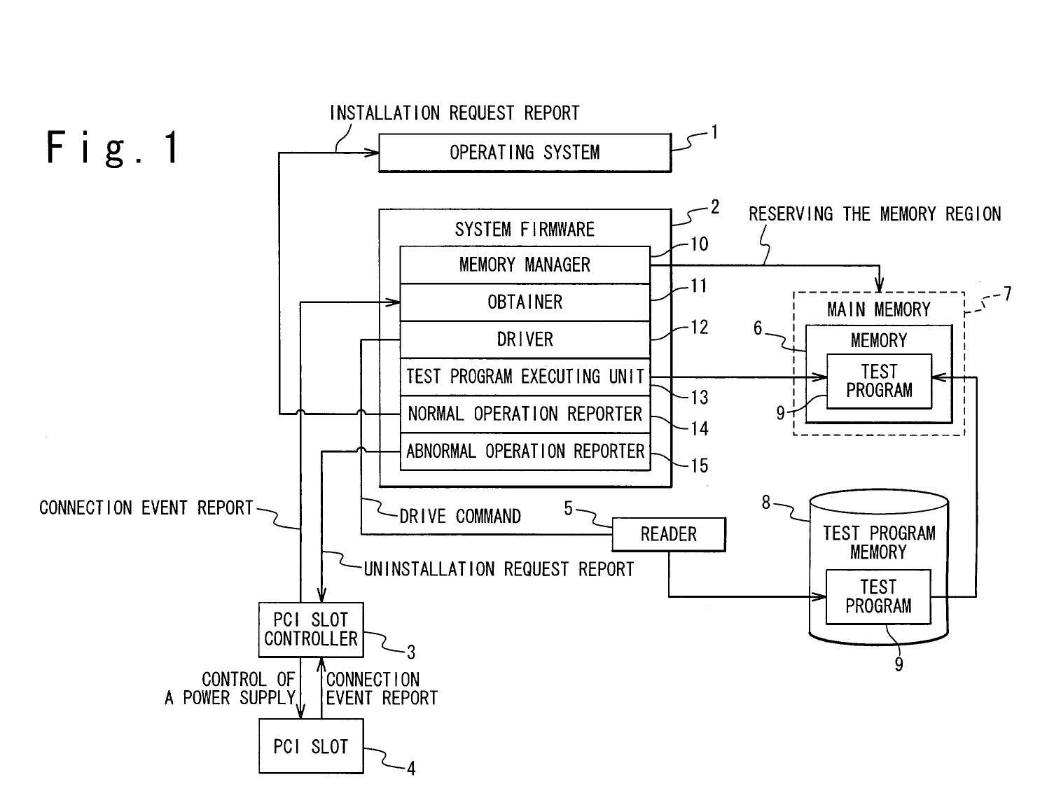

FIG. 1 is a block diagram showing a part of a diagrammatically inner configuration of PC or the like of the first embodiment in the present invention.

FIG. 1 shows: an OS 1 having a plug and play function so as to enable an installation and a setting of a device driver corresponding to peripheral devices including a Small Computer System Interface, an IEEE1394 interface, an IDE controller and the like, which are connected to a PCI slot 4, even during an activation; a system firmware 2 having various units which will be described later; the PCI slot 4 that is a hardware mounted in PC and the like; a PCI slot controller 3, which is a hardware, for carrying out an ON/OFF control of a power supply of the PCI slot 4, and detecting whether or not the peripheral device is connected to the PCI slot 4, and then outputting a connection event report if the connection of the peripheral device is detected; a test program memory 8, such as a magnetic disc apparatus and the like, for storing a test program 9 to test whether or not the peripheral device connected to the PCI slot 4 is normally operated; a reader 5 for reading out the test program 9 stored in the test program memory 8; and a main memory 7 including a memory 6 to accumulate the test program 9 read out by the reader 5.

By the way, a plurality of PCI slots (not shown) are actually connected to the PCI slot controller 3.

The system firmware 2 includes: an obtainer 11 for obtaining a fact that a peripheral device is connected to the PCI slot 4 on the basis of the connection event report outputted by the PCI slot controller 3; a driver 12 for outputting a drive command to the reader 5 in accordance with a trigger signal outputted on the basis of the connection event report from the obtainer 11; a test program executing unit 13 for executing the test program 9 which is read out from the reader 5 by the drive of the driver 12 and then stored in the memory 6; a memory manager 10 for reserving the memory 6 to store the test program 9 in the main memory 7 when the OS 1 is initialized as a region dedicated to the system firmware 2 so that it is not used for the OS 1; a normal operation reporter 14 for outputting an installation request of the peripheral device to the OS 1, if the peripheral device connected to the PCI slot 4 is normally operated, when the program executing unit 13 executes the test program 9; and an abnormal operation reporter 15 for outputting a separating request of the peripheral device to the PCI slot controller 3, if the peripheral device connected to the PCI slot 4 is not normally operated, when the program executing unit 13 executes the test program 9.

By the way, the device driver of the OS 1 and a BI/OS interface such as ACPI (Advanced Configuration and Power Interface Specification) and the like may be included instead of the obtainer 11.

[Explanation of Operation]

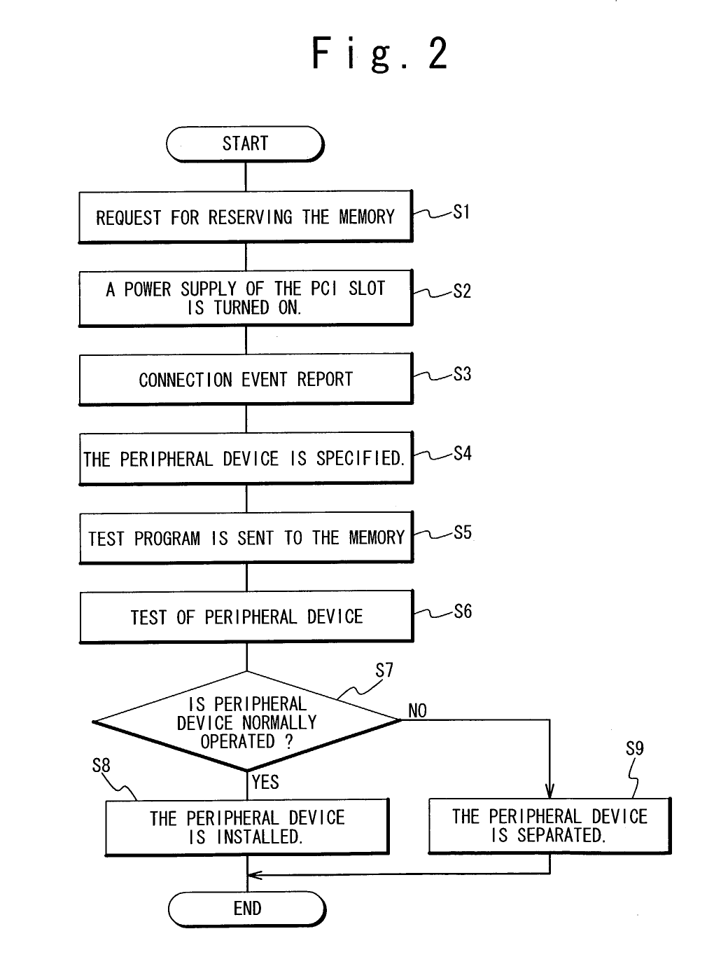

FIG. 2 is a flowchart showing the operation of the PC and the like in FIG. 1. At first, in the system firmware 2, at a time of a system initialization, the memory manager 10 reserves the main memory 7 for the reservation of the memory 6, dedicatedly to the system firmware 2 (Step S1).

That is, with regard to a system memory information to be passed when the OS 1 is activated, the system firmware 2 declares a reservation of a memory region, and insures that it is not used by the OS 1.

If a peripheral device is connected during an on-line operation, the PCI slot 4 detects it, for example, in an electrical manner, and then performs a connection event report on the PCI slot controller 3.

The PCI slot controller 3 turns on a power supply of the PCI slot 4 implying a transmission source of this report, in accordance with the connection event report (Step S2).

Thus, the system firmware 2 can access a PCI configuration space of the information processor connected to the PCI slot 4.

Also, the PCI slot controller 3 performs the connection event report on the obtainer 11 (Step S3).

By the way, the PCI slot controller 3 may perform the connection event report on the obtainer 11 directly or through the OS 1.

The obtainer 11, when receiving the connection event report, outputs a trigger signal, in order to switch the entire system shown in FIG. 1 from a normal mode to a management mode so that the control is shifted to the driver 12.

At this time, the side of the system firmware 2 performs a separation request on the OS 1 so as to carry out the separation between the system firmware 2 and the OS 1. By the way, in a case of a single processor, an interruption request to stop the operation of the OS 1 is carried out.

The driver 12, when receiving the trigger signal from the obtainer 11, obtains a device ID and a vendor ID of the peripheral device, from the PCI configuration space of the peripheral device connected to the PCI slot 4 implying the transmission source of the connection event report, and specifies the peripheral device connected to the PCI slot 4 (Step S4).

Also, the driver 12 drives the reader 5, and requests the reader 5 to read out the test program 9 corresponding to the peripheral device.

In accordance with the reading out request of the driver 12, the reader 5 reads out the test program 9 for the peripheral device connected to the PCI slot 4, and then sends to the memory 6 (Step S5).

When the above-mentioned processes have been ended, the control is shifted to the test program executing unit 13.

The test program executing unit 13 executes the test program 7 sent to the memory 6, and tests the normality of the operation of the peripheral device (Step S6).

The test program executing unit 13 executes the test program 7, and judges whether or not the peripheral device is normally operated (Step S7).

If the peripheral device is normally operated as the judged result, it drives the normal operation reporter 14.

On the other hand, if the peripheral device is not normally operated because of a trouble and the like, it drives the abnormal operation reporter 15.

The normal operation reporter 14 reports to the OS 1 the installation report of the peripheral device connected to the PCI slot 4, and switches the entire system shown in FIG. 1 from the management mode to the normal mode. Then, the control is shifted to the OS 1.

The OS 1 typically loads a device driver corresponding to that peripheral device, and then starts the device driver, and thereby installs the peripheral device under the control (Step S8).

The abnormal operation reporter 15 reports the separation request to the PCI slot controller 3, and suppresses the installation of the peripheral device connected to the PCI slot 4 (Step S9).

Also, the abnormal operation reporter 15 switches the entire system shown in FIG. 1 from the management mode to the normal mode. Then, the control is shifted to the OS 1. In this case, the OS 1 only returns to the process before the shift to the management mode. It is connected to the system firmware 2, or the stop is released and it is operated.

The PCI slot controller 3, when receiving the separation request, turns off the power supply of the PCI slot 4, and flashes or turns on LED and the like, and then indicates a voice information, and thereby reports to a user the failure of the connection of the peripheral device.

As mentioned above, this embodiment has been explained by exemplifying the peripheral device that can be connected to the PCI slot 4. However, the connection manner of the peripheral device is not limited if it can send to the system firmware 2 the connection event report having the information indicative of the peripheral device when the peripheral device is connected during the activation of the OS 1.

Also, if the resource management through the connection of the peripheral device during the activation of the OS 1 is supported on the side of the OS 1, it is possible to apply not only to the PC but also to a body system apparatus, such as a memory, a workstation, a server, a processor and the like, and a peripheral device in an I/O system.

(Second Embodiment)

[Explanation of Configuration]

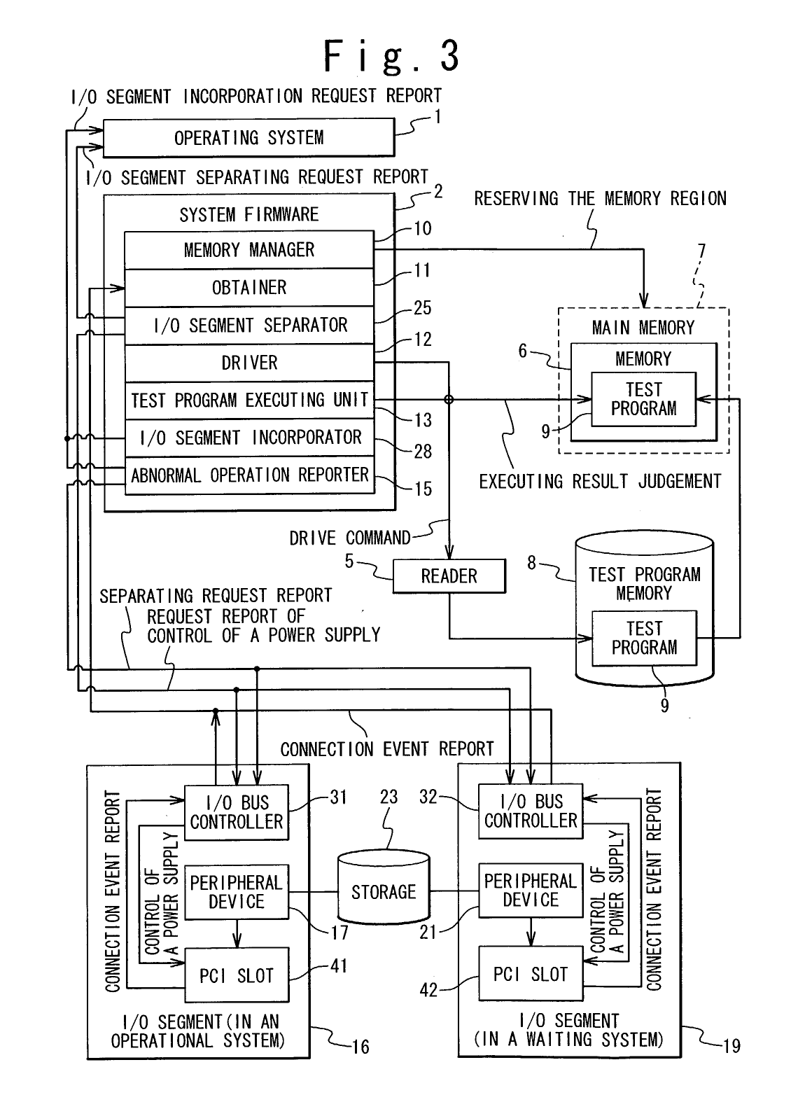

FIG. 3 is a block diagram showing a diagrammatically inner configuration of PC or the like of a second embodiment in the present invention.

FIG. 3 shows: I/O segments 16, 19, which include I/O bus controllers 31, 32 that are one implementation of the PCI slot controller 3, PCI slots 41, 42 and peripheral devices 17, 21 and can be I/O-accessed by the OS 1; and a storage 23 of a redundant configuration, which stores an information to be used in the OS 1 and can be accessed from the peripheral devices 17, 21.

Incidentally, the I/O segment 16 is defined as an I/O segment in an operational system used for the I/O access during the normal OS 1 operation. The I/O segment 19 is defined as an I/O segment in a waiting system to be used for an access as a variation path, if an occurrence of a trouble in the I/O segment 16 disables the I/O access.

However, the I/O segments 16, 19 may be both designed to support the redundant configuration as the operational system.

Also, FIG. 3 shows the system firmware 2 including: an I/O segment separator 25 for reporting a separation request of the I/O segment 16 to the OS 1, instead of the normal operation reporter 14; and an I/O segment incorporator 28 for performing an incorporation request of the I/O segment 16 on the OS 1 if there is no abnormality in the peripheral device 17.

By the way, the I/O segment separator 25, when the OS 1 requests the command for turning on the power supply of the PCI slot 41 to which the peripheral device 17 is connected after the separation of the I/O segment 16, for example, when the connection to the system side can not be successfully set since dust and the like are deposited on a connection terminal of the peripheral device 17, even if a trouble is erroneously judged to be induced in a bus through which the system and the peripheral device 17 are connected, in order to avoid the report of the judged result from being sent to the OS 1, sends a report to suppress an output of the report to the side of the I/O segment 16 to the I/O bus controller 31, and uses a function typically provided by a hardware and switches the entire system from the normal mode to the management mode so that the control is shifted to the driver 12 of the system firmware 2.

By the way, since the I/O segment separator 25 can use a typical ACPI (Advanced Configuration and Power interface) or OSPM (OS Directed Power Management) interruption function and a typical ACPI method function, strictly, it does not need to be included in the system firmware 2. Also, since the I/O segment incorporator 28 can use the typical ACPI interruption function, strictly, it does not need to be included in the system firmware 2.

Also, the test program executing unit 13 activates the I/O segment incorporator 28 or the abnormal operation reporter 15.

The abnormal operation reporter 15 performs the separation request of the peripheral device 17 on the I/O bus controller 31, and if another peripheral device is already connected before the peripheral device 17 is connected to the I/O bus controller 31, reports an I/O segment incorporation request to the OS 1 so that the peripheral device 17 again incoporates the separated I/O bus controller 31.

[Explanation of Operation]

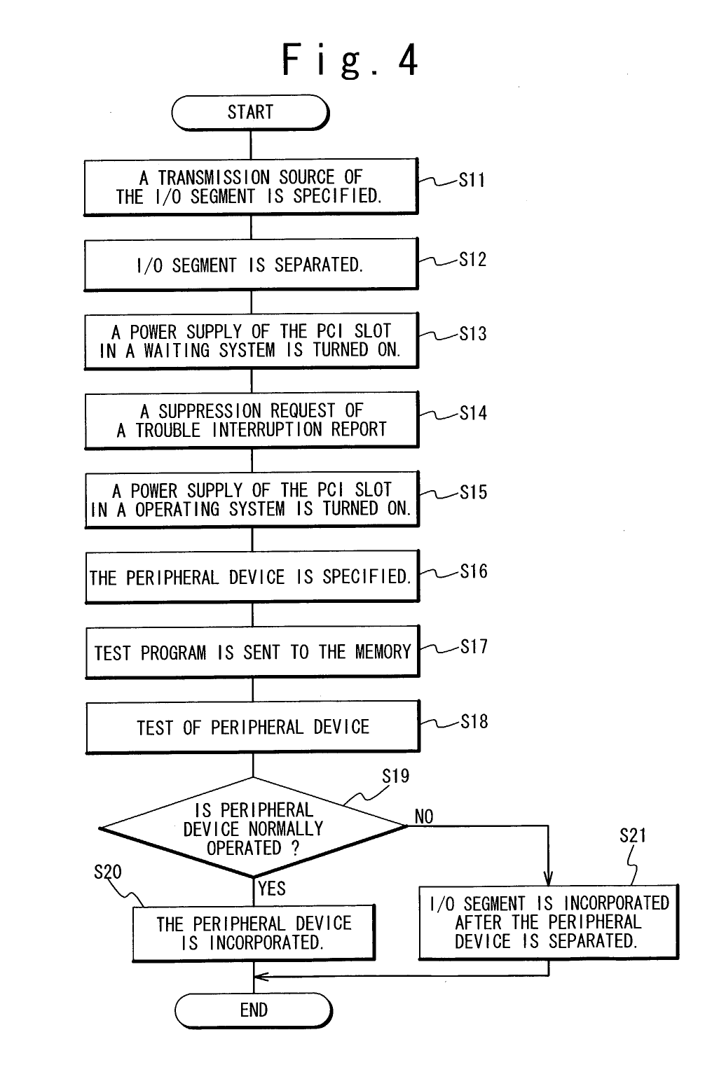

FIG. 4 is a flowchart showing the operation of the PC or the like of FIG. 3. By the way, the processes from the operation for detecting that the peripheral device 17 is connected to the PCI slot 41 until the operation for carrying out the connection event report to the obtainer 11 of the system firmware 2 are similar to those of the first embodiment. Incidentally, this is explained under the assumption that a peripheral device different from the peripheral device 17 is already connected to the I/O segment 16.

The obtainer 11, when receiving the connection event report, specifies that a transmission source of the report is the I/O segment 16, and outputs the information indicative of the specified transmission source to the I/O segment separator 25 (Step S11).

The I/O segment separator 25 reports a request to turn on the power supply of the PCI slot 42 to the I/O bus controller 32, and reports the separation request to the OS 1 so as to separate the I/O segment 16 from the OS 1.

The OS 1 specifies the peripheral device 17 and separates it, in accordance with the separation request reported by the I/O segment separator 25 (Step S12).

The I/O bus controller 32 turns on the power supply of the PCI slot 42, on the basis of the request report to turn on the power supply from the I/O segment separator 25 (Step S13).

Also, the OS 1 uses the side of the I/O segment 19 when accessing the storage 23, since the side of the I/O segment 19 is activated.

When the separation of the I/O segment 16 has been completed by the OS 1, the I/O segment separator 25 reports the request to turn on the power supply of the PCI slot 41 to the I/O bus controller 31.

Also, the I/O segment separator 25, actually, when the peripheral device 17 can normally carry out the necessary operation, for example, when the connection to the system side can not be successfully set since dust and the like are deposited on the connection terminal of the peripheral device 17, even if a trouble is erroneously judged to be induced in the bus through which the system and the peripheral device 17 are connected, in order to avoid the erroneously judged result from being sent to the OS 1, reports a suppression request of a trouble interruption report (Step S14).

The I/O bus controller 31 turns on the power supply of the PCI slot 41, in accordance with the report from the I/O segment separator 25 (Step S15).

Consequently, the peripheral device 17 connected to the PCI slot 41 can access a PCI configuration I/On space. Also, even if a trouble that may present a bus trouble to the peripheral device 17 is induced, a test of the peripheral device 17 can be done without any influence on the OS 1.

Also, the I/O segment separator 25 uses the function typically provided by the hardware, and switches the entire system shown in FIG. 1 from the normal mode to the management mode, and then outputs a trigger signal so that the control is shifted to the driver 12.

The driver 12, when receiving the trigger signal from the obtainer 11, obtains a device ID and a vendor ID of the peripheral device 17, from a PCI configuration I/On space of the peripheral device 17 inserted into the PCI slot 4 of the transmission source of the connection event report, and specifies that the peripheral device connected to the PCI slot 41 is the peripheral device 17 (Step S16).

Also, the driver 12 drives the reader 5, and requests the reader 5 to read out the test program 9 corresponding to the peripheral device 17.

In accordance with the reading out request of the driver 12, the reader 5 reads out the test program 9 for the peripheral device connected to the PCI slot 41, and then sends to the memory 6 (Step S17).

When the above-mentioned processes have been ended, the control is shifted to the test program executing unit 13.

The test program executing unit 13 executes the test program 9 sent to the memory 6, and tests the normality of the operation of the peripheral device 17 (Step S18).

The test program executing unit 13 executes the test program 9, and judges whether or not the peripheral device is normally operated (Step S19).

If the peripheral device is normally operated as the judged result, it uses the ACPI interruption. Then, the control is shifted to the I/O segment incorporator 28.

On the other hand, if the peripheral device is not normally operated by a trouble and the like as the judged result, it drives the abnormal operation reporter 15.

The I/O segment incorporator 28 switches the system from the management mode to the normal mode, and releases the suppression of the interruption request report to the OS 1 from the I/O segment 16. The I/O segment incorporator 28 performs the request report on the OS 1 so as to incorporate the I/O segment 16.

Typically, the OS 1 scans the I/O segment, to which the incorporation request is reported, for the connection of a peripheral device. If a peripheral device is already connected besides the newly connected peripheral device, it loads the device drivers corresponding to all of the peripheral devices, and installs the peripheral devices under the control of the peripheral device (Step S20).

The abnormal operation reporter 15 reports the separation request to the I/O bus controller 31, and suppresses the installation of the peripheral device connected to the PCI slot 41. Also, the abnormal operation reporter 15 switches the entire system shown in FIG. 1 from the management mode to the normal mode. Then, the control is shifted to the OS 1. In this case, the OS 1 only returns to the process before the shift to the management mode.

The I/O bus controller 31, when receiving the separation request report from the abnormal operation reporter 15, turns off the power supply of the PCI slot 41, and flashes or turns on the LED and the like, and then indicates the voice information, and thereby reports to the user the failure of the connection of the peripheral device.

The abnormal operation reporter 15 releases the suppression of the interruption request report to the OS 1 from the I/O segment 15. As for the already-connected peripheral device except the peripheral device 17, on the basis of the ACPI interruption, the control is shifted to the I/O segment incorporator 28. Also, it switches the system from the management mode to the normal mode (Step S21).

At this time, the separation and the incorporation are carried out with the I/O segment as a unit. Thus, even if the peripheral device 17 is not normally operated, it is possible to prevent the peripheral device 17 from having a bad influence on the OS 1.

As mentioned above, according to the present invention, the test program is executed in accordance with the command from the firmware without any obedience to the OS command. Thus, it is possible to generally test whether or not the peripheral device is normally operated.

Also, according to the present invention, the test of the peripheral device is done in the system firmware. Thus, the I/O bus controller having the PCI slot controller can use a PCI bridge supporting a hot plug without any need for containing the CPU to test the peripheral device. That is, this has the merit that it is not necessary to prepare the hardware dedicated to the execution of the test.

Also, in the system firmware, the memory for storing the test program is reserved such that the connection between the OS and the memory can not be established. Thus, the I/O bus controller containing the PCI slot controller need not have the memory for storing the test program. The test program is stored in the test program memory that is the external memory and it is not the device. Hence, a PCI card and the like can be targeted for the test.

Moreover, according to the present invention, the peripheral device can be tested without any dependence on the structure of the device driver of the OS. Thus, it is enough to include the OS supporting the PCI hot plug such as the OS for the PC, and it is not necessary to include the software such as the device driver depending on the OS. Thus, if only the test program that can be operated on an off-line is developed, it is not necessary to develop the test program for the same peripheral device for each OS. Thus, the number of the development steps for the test program can be reduced. Moreover, the test of the peripheral device can be executed even if a functional addition and a functional change are not performed on the OS.

Also, according to the present invention, without any inclusion of a hot plug controller having a special path, only the typical hot plug controller can be used to test the peripheral device.

What is claimed is:

1. A peripheral device testing apparatus, comprising:
an executing unit included in a firmware installed on an information processing apparatus, wherein said executing unit executes a test program for testing a peripheral device connected to said information processing apparatus to generate a testing result; and
a reporting unit included in said firmware, wherein said reporting unit outputs an installation request indicating of requesting to install said peripheral device on said information processing apparatus to an operating system installed on said information processing apparatus when an operation of said peripheral device is normal as a result of said testing result.

2. A peripheral device testing apparatus, comprising:
an executing unit included in a firmware installed on an information processing apparatus, wherein said executing unit executes a test program for testing a peripheral device connected to a connection section of said information processing apparatus to generate a testing result; and
a specific reporting unit included in said firmware, and
wherein said connection section separates said peripheral device from said information processing apparatus in response to a separating request, and
wherein said specific reporting unit outputs said separating request to said connection section when said operation of said peripheral device is abnormal as said result of said testing result.

3. The peripheral device testing apparatus according to claim 2, wherein said connection section outputs a connection information indicating that said peripheral device is connected to said connection section to said firmware when said peripheral device is connected to said connection section.

4. The peripheral device testing apparatus according to claim 3, wherein a plurality of said peripheral devices are able to be connected to said connection section, and
wherein said connection information includes an identifier of one of said plurality of said peripheral devices connected to said connection section, and
wherein a plurality of said test programs are corresponding to said plurality of said peripheral devices, respectively, and
wherein said executing unit executes said test program corresponding to said peripheral device of said identifier included in said connection information inputted by said firmware.

5. The peripheral device testing apparatus according to claim 1, wherein said test program is stored into said information processing apparatus.

6. The peripheral device testing apparatus according to claim 5, wherein a part of a memory of said information processing apparatus is set to be a memory area into which said test program is written, and said part is set to be said memory area that said firmware can use but said operating system cannot use.

7. The peripheral device testing apparatus according to claim 2, wherein said firmware makes one of a first request of an operating system installed on said information processing apparatus to be disconnected from said firmware and a second request of said operating system to stop an operation of said operating system when said peripheral device is connected to said connection section.

8. The peripheral device testing apparatus according to claim 7, wherein said executing unit executes said test program after said operating system is disconnected from said firmware or said operating system stops said operation of said operating system.

9. The peripheral device testing apparatus according to claim 1, wherein said information processing apparatus is any one of a personal computer, a memory, a server, a workstation and a processor.

10. The peripheral device testing apparatus according to claim 1, further comprising:
a bus which connects said operating system to said peripheral device at a normal state;
an interrupting unit which interrupts said bus before said executing unit executes said test program;
a returning unit which returns said interrupted bus to said normal state when said operation of said peripheral device is normal as said result of said testing result.

11. The peripheral device testing apparatus according to claim 1, wherein said peripheral device includes a storage into which an information used by said operating system is stored, and a connecting section which connects said storage to said information processing apparatus.

12. A peripheral device testing apparatus, comprising:
a first connection section included in an information processing apparatus, wherein a first peripheral device is connected to said first connection section and said first connection section is accessible by an operating system of said information processing apparatus;
a second connection section included in said information processing apparatus, wherein a second peripheral device is connected to said second connection section and said second connection section is accessible by said operating system;
a disconnect unit which outputs a disconnect request indicating of disconnecting said first connection section from said operating system to said operating system when said first peripheral device is connected to said first connection section, wherein said disconnect unit outputs a first power-ON request indicating of supplying a power supply to a first connecting unit through which said first peripheral device is connected to said first connection section to said first connection section after said operating system disconnects said first connection section from said operating system in response to said disconnect request, and wherein said first connection section turns on a power for said first connecting unit in response to said first power-ON request;
an executing unit included in a firmware installed on said information processing apparatus, wherein said executing unit executes a test program for testing said first peripheral device to generate a testing result after said power for said first connecting unit is turned on; and
an incorporating section, wherein said incorporating section outputs an incorporating request indicating of requesting to incorporate said first connection section into said information processing apparatus to said operating system when an operation of said first peripheral device is normal as a result of said testing result.

13. A peripheral device testing apparatus, comprising:
a first connection section included in an information processing apparatus, wherein a first peripheral device is connected to said first connection section and said first connection section is accessible by an operating system of said information processing apparatus;
a second connection section included in said information processing apparatus, wherein a second peripheral device is connected to said second connection section and said second connection section is accessible by said operating system;
a disconnect unit which outputs a disconnect request indicating of disconnecting said first connection section from said operating system to said operating system when said first peripheral device is connected to said first connection section, wherein said disconnect unit outputs a first power-ON request indicating of supplying a power supply to a first connecting unit through which said first peripheral device is connected to said first connection section to said first connection section after said operating system disconnects said first connection section from said operating system in response to said disconnect request, and wherein said first connection section turns on a power for said first connecting unit in response to said first power-ON request;
an executing unit included in a firmware installed on said information processing apparatus, wherein said executing unit executes a test program for testing said first peripheral device to generate a testing result after said power for said first connecting unit is turned on; and
a specific reporting unit included in said firmware, and
wherein said first connection section separates said first peripheral device from said information processing apparatus in response to a separating request, and
wherein said specific reporting unit outputs said separating request to said first connection section when said operation of said first peripheral device is abnormal as said result of said testing result.

14. The peripheral device testing apparatus according to claim 12, wherein said disconnect unit outputs, to said first connection section, an output prohibition request indicating of prohibition of outputting a judgement result that a failure occurs in a bus connected to said first peripheral device to said operating system, and
wherein said first connection section does not output said judgement result to said operating system in response to said output prohibition request.

15. The peripheral device testing apparatus according to claim 13, wherein said disconnect unit outputs, to said first connection section, an output prohibition request indicating of prohibition of outputting a judgement result that a failure occurs in a bus connected to said first peripheral device to said operating system, and
wherein said first connection section does not output said judgement result to said operating system in response to said output prohibition request.

16. The peripheral device testing apparatus according to claim 12, wherein said disconnect unit outputs a second power-ON request indicating of supplying a power supply to a second connecting unit through which said second peripheral device is connected to said second connection section to said second connection section when said first peripheral device is connected to said first connection section, and
wherein said second connection section turns on a power for said second connecting unit in response to said second power-ON request.

17. The peripheral device testing apparatus according to claim 16, further comprising:
a storage into which an information used by said operating system is stored and which is accessible by said first and second peripheral devices, and
wherein said operating system accesses to said storage with said second peripheral device.

18. A peripheral device testing method, comprising:
(a) executing a test program for testing a peripheral device connected to an information processing apparatus to generate a testing result in response to a command from a firmware of said information processing apparatus; and
(b) outputting an installation request indicating of requesting to install said peripheral device on said information processing apparatus to an operating system installed on said information processing apparatus when an operation of said peripheral device is normal as a result of said testing result.

19. A peripheral device testing method, comprising:
(c) executing a test program for testing a peripheral device connected to a connection section of an information processing apparatus to generate a testing result in response to a command from a firmware of said information processing apparatus;
(d) separating said peripheral device from said information processing apparatus in response to a separating request; and
(e) outputting said separating request to said connection section when said operation of said peripheral device is abnormal as said result of said testing result.

20. A peripheral device testing method, comprising:
(f) providing a first connection section included in an information processing apparatus, wherein a first peripheral device is connected to said first connection section and said first connection section is accessible by an operating system of said information processing apparatus;
(g) providing a second connection section included in said information processing apparatus, wherein a second peripheral device is connected to said second connection section and said second connection section is accessible by said operating system;
(h) disconnecting said first connection section from said operating system when said first peripheral device is connected to said first connection section;
(i) supplying a power supply to a first connecting unit through which said first peripheral device is connected to said first connection section after said (h);
(j) executes a test program for testing said first peripheral device to generate a testing result after said (i); and
(k) incorporating said first connection section into said information processing apparatus when an operation of said first peripheral device is normal as a result of said testing result.
